(19) United States
(12) Patent Application Publication
(10) Pub. No.: US 2016/0207055 A1
(43) Pub. Date: Jul. 21, 2016

(54) LINE MARKING APPARATUS HAVING A CLOSED CIRCULATION SYSTEM

(71) Applicant: DIGITAL LINE MARKERS FZE, Sharjah (AE)

(72) Inventor: Iain PETER MCGUFFIE, Nr. Bromyard (GB)

(73) Assignee: DIGITAL LINE MARKERS FZE, Sharjah (AE)

(21) Appl. No.: 14/392,366

(22) PCT Filed: Jul. 15, 2014
(86) PCT No.: PCT/IB2014/063113

§ 371 Date: Feb. 1, 2016

(30) Foreign Application Priority Data
Jul. 30, 2013 (GB) 1313536.3

(51) Int. Cl. B05B 7/26; B05B 12/00; B05B 13/00; B05B 7/00

(52) U.S. Cl. CPC B05B 7/26; B05B 7/0093; B05B 12/008; B05B 13/005

(57) ABSTRACT

A line marking apparatus includes a closed circuit circulation system for line marking material. The circulation system comprises a pump (17) for circulating line marking material under pressure through the circuit from an outlet of the pump back to an inlet thereof. The circulation system also comprises an inlet (15) for introducing fresh line marking material to the circuit when required, the inlet being positioned upstream of the inlet of the pump. The circulation system further comprises means (19, 25) for controlling the pressure of line marking material downstream of the outlet of the pump. The circulation system moreover comprises an outlet for conducting pressurized line marking material to a spray nozzle (21) for marking a line (23) with the line marking material when the fluid pressure in the circulation system exceeds a threshold.

This invention relates to a line marking apparatus having a closed circulation system.

Line marking apparatus conventionally applies a spray of line marking material (paint) to a surface being marked, but one of the problems associated with such apparatus is arranging the spray such that the edges of the marked line are sharp and distinct. A number of different factors are involved, but one factor concerns the rheological properties of the line marking material and maintaining the rheological properties constant. It is well known that line marking materials for line marking apparatus are thixotropic and the rheological properties therefore vary during use of a line marking apparatus. This results in the quality of the edges of the line being marked varying during use of a line marking apparatus, either the quality of the edges deteriorates during use or the quality improves during use.

It is therefore an object of the present invention to provide a line marking apparatus in which the quality of the edges of a marked line remains substantially constant.

According to the present invention there is provided a line marking apparatus including a closed circuit circulation system for line marking material comprising: a pump for circulating line marking material under pressure through the circuit from an outlet of the pump back to an inlet thereof; an inlet for introducing fresh line marking material to the circuit when required, the inlet being positioned upstream of the inlet of the pump; means for controlling the pressure of line marking material downstream of the outlet of the pump; and an outlet for conducting pressurised line marking material to a spray nozzle for marking a line with the line marking material when the fluid pressure in the circulation system exceeds a threshold.

A non-return valve may be provided upstream of the closed circuit circulation system.

Line marking material may enter the closed circuit circulation system by way of an inlet in the form of a T-junction.

The means for controlling the pressure downstream of the outlet of the pump may comprise pressure control valve, which may be adjustable, for example manually or automatically. The pressure control valve may incorporate an outlet in the form of a diverter valve.

Alternatively, the means for controlling the pressure downstream of the pump outlet may comprise the piping for the closed circuit, the dimensions of the piping being adapted to create a resistance to flow from the pump. In such a case, the rate at which the pump operates may be controlled. In such a case, the flow of line marking material to the spray nozzle may be by way of a separate diverter valve, which itself may be adjustable and/or which may be positioned in piping leading to the spray nozzle.

Alternatively, the pressure control valve and the diverter valve may be separate. In such a case, the pressure control valve may be located downstream of the pump, but at a point upstream of the inlet for fresh line marking material. The pressure control valve may be positioned in piping between the inlet of the pump and the outlet of the diverter valve, or alternatively in piping leading to the spray nozzle. One or both of the pressure control valve and the diverter valve may be adjustable if desired.

The pump may be a suction pump.

The line marking apparatus may include a body provided with wheels. The apparatus may further include a handle or other means for propelling the apparatus.

The line marking apparatus may include a source of line marking material and/or a source of water. The or each source may comprise a tank or a replaceable (for example, collapsible) bag. Where both a line marking material source and a water source are provided, a multi-way valve may be provided to select the desired source. In any event an on-off valve may be provided, incorporated into the multi-way valve where present. The or each valve may be manually operable valve or electromechanically operable.

For a better understanding of the present invention and to show more clearly how it may be carried into effect reference will now be made, by way of example, to the accompanying drawings in which:

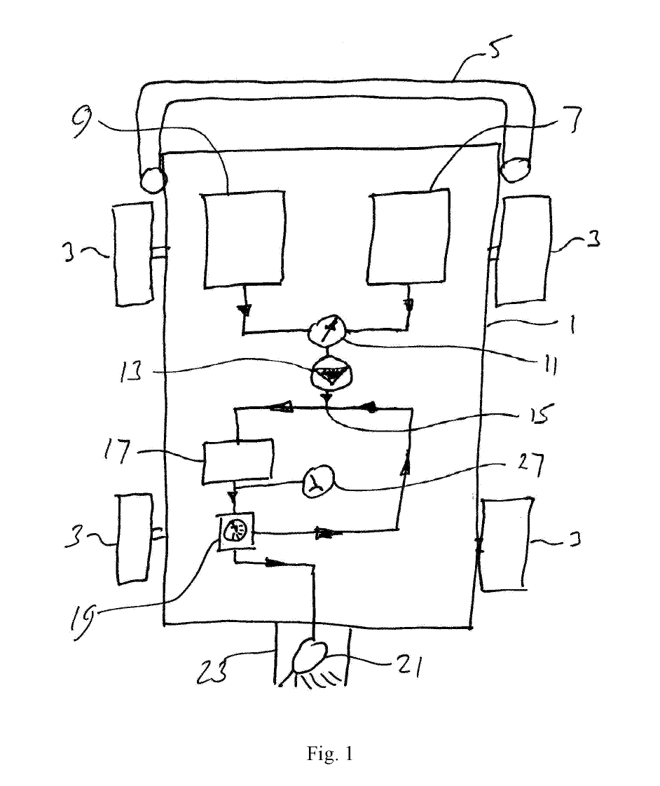

FIG. 1 is a diagrammatic illustration of a line marking apparatus according to the present invention having a closed circuit circulation system;

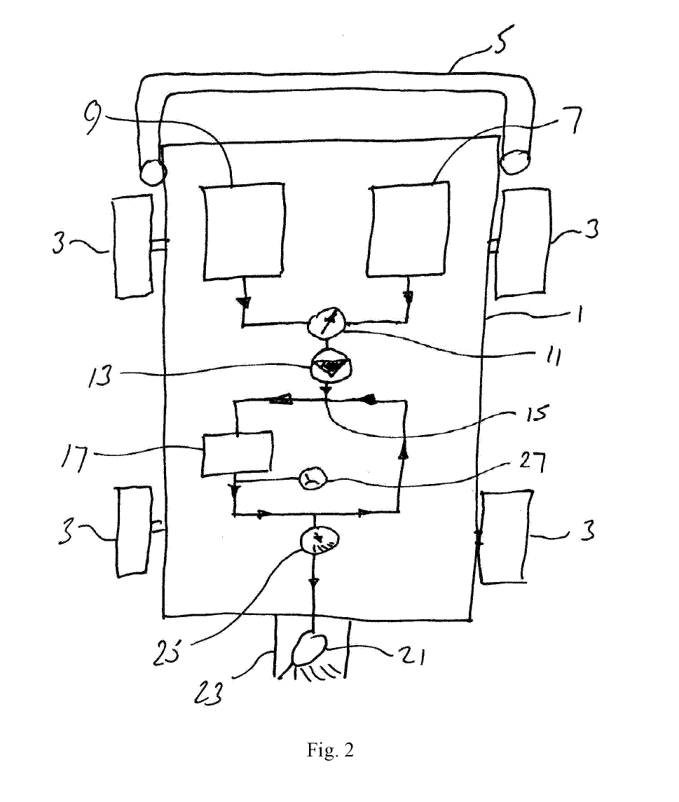

FIG. 2 is a diagrammatic illustration of a modification of part of the line marking apparatus shown in FIG. 1; and

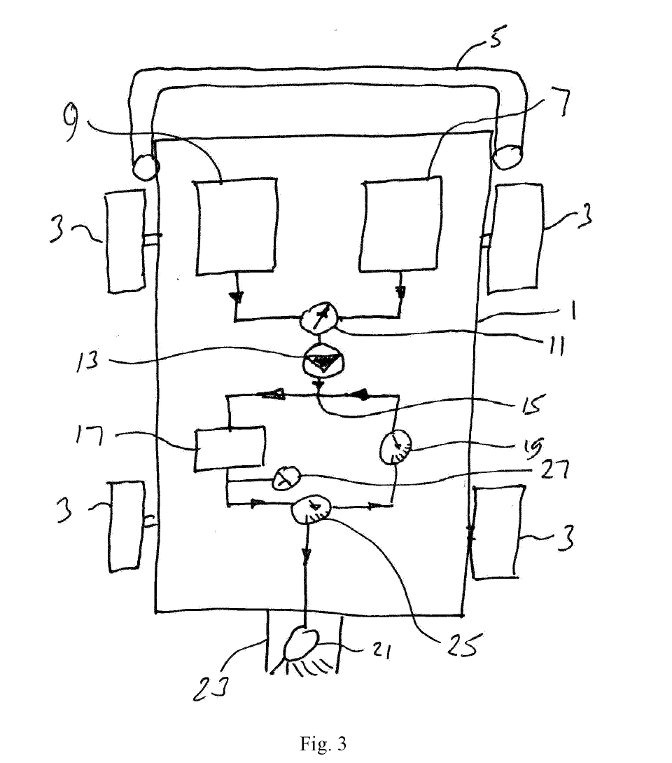

FIG. 3 is a diagrammatic illustration of a further modification of part of the line marking apparatus shown in FIG. 1.

The line marking apparatus shown in FIG. 1 includes a body 1 provided with a wheels 3 and a handle 5 for propelling the apparatus. Alternatively, the apparatus could be self-propelled.

The apparatus further includes a source 7 of line marking material (paint) for marking a line and a source 9 of water for washing out the spraying system after use. The line marking material source and or the water source may each comprise, for example, a tank or a replaceable, collapsible bag. A replaceable flexible bag has the advantage that the bag collapses as the line marking material is used without introducing air into the bag with the potential for causing the line marking material to deteriorate before it is applied. Either the line marking material source 7 or the water source 9 can be selected by way of a three-way valve 11, which may be a manually operable valve or an electromechanically operable valve. If desired, the valve 11 may additionally have an “off” setting so that neither line marking material nor water can pass through the valve.

The line marking material or water then passes through a non-return valve 13 to a closed circuit circulation system. If desired, the non-return valve 13 may be incorporated into the valve 11. The closed circuit circulation system will be described in relation to the use thereof with line marking material, although water may equally flow around the system for cleaning purposes.

Line marking material enters the closed circuit circulation system from the non-return valve 13 by way of an inlet in the form of a T-junction 15, the line marking material being drawn into the system, when required, by a pump 17, such as a suction pump. Line marking material is recirculated from the outlet of the pump 17 back to the T-junction 15 and from the T-junction to the inlet of the pump, thus giving rise to the closed circuit circulation system. A pressure control valve 19 is incorporated in the system. As illustrated, the pressure control valve 19 incorporates a diverter valve (alternatively known as a pressure reducing valve) so as to pass line marking material to and out of a spray nozzle 21 when the fluid pressure in the circulation system exceeds a threshold. The pressure control valve 19 may be adjustable, most simply manually but automatic control may be provided if desired, so as to vary the threshold, for example up to about 5 bar although different thresholds may be employed if desired, and to control the fluid pressure in the circulation system. The rheological properties of the thixotropic line marking material vary according to the way in which the line marking material is treated (such as the shear forces applied to the material), so an ability to vary the pressure threshold allows the rheological properties to be varied, either manually or automatically, so as to adjust the properties of the line marking material being sprayed and consequently the outline of the line 23 being marked. Line marking material leaving the control valve 19 and not passing to the nozzle 21 returns to the T-junction 15 and to the pump 17, from where it is pumped back to the control valve 19, completing the closed circuit. A pressure gauge 27 is provided for indicating the pressure of the line marking material in the closed loop system, that is, downstream of the pump 17.

The closed circuit arrangement of FIG. 1 may be modified in a number of ways while remaining a closed circuit.

For example, the dimensions of the piping for the closed circuit may be such as to create a resistance to flow from the pump 17 such as to eliminate the need for a separate control valve. Adjustment of the rheological properties of the thixotropic line marking material may then be accomplished by varying the rate at which the pump operates. In such a case, the flow of line marking material to the spray nozzle 21 may be by way of a separate diverter valve 25, which itself may be adjustable and/or which may be positioned in piping leading to the spray nozzle 21 or in the spray nozzle itself such that line marking material exits the spray nozzle when the fluid pressure exceeds a threshold, which may be variable. Such an arrangement is shown in FIG. 2.

An embodiment of the present invention with a separate pressure control valve 19 and diverter valve 25 is shown in FIG. 3. As shown in the modification of FIG. 3, pressure control valve 19 is located downstream of the pump 17 but at a point upstream of the T-junction 15 where fresh line marking material is introduced when required. Thus, the rheological properties of the line marking material are adjusted in the region from the inlet of the pump 17 to the outlet of the pressure control valve 19. The pressure control valve 19 is positioned in the piping between the inlet of the pump and the outlet of the diverter valve 25, or alternatively the diverter valve may be positioned in piping leading to the spray nozzle 21 or in the spray nozzle itself, so as to allow line marking material to pass out of the spray nozzle 21 when the fluid pressure in the circulation system exceeds a threshold. One or both of the pressure control valve and the diverter valve may be adjustable if desired.

The use of a closed circuit, rather than returning the line marking material to the source 7, ensures that the line marking material is returned to the inlet of the pump 17 under a pressure corresponding to the weakest pressure relief valve in the closed loop system. The line marking material is subjected to pressure and shear forces which result in a change in the viscosity of the line marking material compared with the material stored in the source 7. This helps to maintain a desired rheological properties, especially viscosity, for the line marking material exiting the spray nozzle 21, resulting in a substantially clean line being marked with no overspray. The ability to adjust the pressure within the closed loop, where provided, allows adjustment to compensate, for example for changes in ambient temperature and for differing rheological properties of various line marking materials.

Where the water source 9 is also a replaceable, collapsible bag a duplicate closed system may be provided for passing water through the system and to the nozzle for cleaning purposes.

1. A line marking apparatus including a closed circuit circulation system for line marking material comprising: a pump (17) for circulating line marking material under pressure through the circuit from an outlet of the pump back to an inlet thereof; an inlet (15) for introducing fresh line marking material to the circuit when required, the inlet being positioned upstream of the inlet of the pump; means (19, 25) for controlling the pressure of line marking material in the closed circuit circulation system; and an outlet for conducting pressurised line marking material to a spray nozzle (21) for marking a line (23) with the line marking material when the fluid pressure in the circulation system exceeds a threshold.

2. An apparatus as claimed in claim 1, wherein a non-return valve (13) is provided upstream of the closed circulation system.

3. An apparatus as claimed in claim 1, wherein an inlet to the closed circuit circulation system comprises a T-junction (15).

4. An apparatus as claimed in claim 1, wherein the means for controlling the pressure downstream of the outlet of the pump (17) comprises a pressure control valve (19).

5. An apparatus as claimed in claim 4, wherein the pressure control valve (19) is adjustable.

6. An apparatus as claimed in claim 4, wherein wherein the pressure control valve (19) incorporates an outlet in the form of a diverter valve (25).

7. An apparatus as claimed in claim 1, wherein the means for controlling the pressure downstream of the pump outlet comprises the piping for the closed circuit, the dimensions of the piping being adapted to create a resistance to flow from the pump (17).

8. An apparatus as claimed in claim 7 and including means for controlling the rate at which the pump (17) operates.

9. An apparatus as claimed in claim 7, wherein the flow of line marking material to the spray nozzle (21) is by ay of a separate diverter valve (25).

10. An apparatus as claimed in claim 9, wherein the separate diverter valve (25) is adjustable.

11. An apparatus as claimed in claim 9, wherein the separate diverter valve (25) is positioned in piping leading to the spray nozzle (21).

12. An apparatus as claimed in claim 4 and including a diverter valve (25) separate from the pressure control valve (19).

13. An apparatus as claimed in claim 12, wherein the pressure control valve (19) is located downstream of the pump (17), but at a point upstream of the inlet (15) for fresh line marking material.

14. An apparatus as claimed in claim 12, wherein the pressure control valve (19) is positioned in piping between the inlet of the pump (17) and the outlet of the diverter valve (25).

15. An apparatus as claimed in claim 12, wherein the diverter valve (25) is positioned in piping leading to the spray nozzle (21).

16. An apparatus as claimed in claim 12, wherein one or both of the pressure control valve (19) and the diver valve (25) is adjustable.

17. An apparatus as claimed in claim 1, wherein the pump (17) is a suction pump.

18. An apparatus as claimed in claim 1 and including a body (1) provided with wheels (3).

19. (canceled)

20. An apparatus as claimed in claim 1 and including a source (7) of the line marking material.

21. An apparatus as claimed in claim 1 and including a source (9) of water.

22. An apparatus as claimed in claim 20, wherein the source (7) comprises a tank or a replaceable bag.

23. An apparatus as claimed in claim 22, wherein the replaceable bag comprises a collapsible bag (7).

24. An apparatus as claimed in claim 1 and including a line marking material source (7) and a water source (9) are provided, wherein a multi-way valve (11) is provided to select the desired source.

25. An apparatus as claimed in claim 24, wherein an on-off valve is provided.

26. An apparatus as claimed in claim 25, wherein the on-off valve is incorporated into the multi-way valve (11).

27. An apparatus as claimed in claim 24, wherein the valve (11) is manually operable or electromechanically operable.
